(19) United States
(12) Patent Application Publication
(10) Pub. No.: US 2026/0303961 A1
(43) Pub. Date: Oct. 1, 2026

(54) ELECTRONIC DEVICE AND PHOTOGRAPHING TIME CONTROL METHOD THEREOF

(71) Applicant: ASUSTeK COMPUTER INC., Taipei City (TW)

(72) Inventors: Chun-Yen Liao, Taipei City (TW); Chang-Tai Lee, Taipei City (TW)

(73) Assignee: ASUSTeK COMPUTER INC., Taipei City (TW)

(21) Appl. No.: 19/564,208

(22) Filed: Mar. 12, 2026

(30) Foreign Application Priority Data
Mar. 25, 2025 (TW) 114111102

(51) Int. Cl. H04N 23/60; H04N 23/62; H04N 23/951

(52) U.S. Cl. CPC H04N 23/64; H04N 23/62; H04N 23/665; H04N 23/951

(57) ABSTRACT

An electronic device and a photographing time control method thereof are provided. The method is adapted to the electronic device including an image sensor and comprises the following steps. A photographing interval time is determined according to a predetermined number of continuous shots and a maximum storage capacity of a frame queue. The photographing interval time is configured to determine whether a user photographing request is accepted. When the user photographing request is accepted, multiple image frames captured by the image sensor are temporarily stored in the frame queue. A composite image is generated based on the image frames in the frame queue, and the composite image is stored in a format that complies with an image storage format.

### CROSS-REFERENCE TO RELATED APPLICATION

This application claims the priority benefit of Taiwan application serial no. 114111102, filed on Mar. 25, 2025. The entirety of the above-mentioned patent application is hereby incorporated by reference herein and made a part of this specification.

### BACKGROUND

### Technical Field

The disclosure relates to a photographing time control method and an electronic device using this method.

### Related Art

With the continuous advancement of technology, electronic devices with image extraction capabilities have deeply integrated into modern daily life. To further enhance photo quality, many devices adopt multi-frame composite algorithms to optimize imaging effects. However, during the process of multi-frame image extraction, the multiple frames captured by the image sensor are usually first stored in a frame queue, and then processed for image enhancement and composite processing through a multi-thread system. However, due to limited system resources, the frame queue may become full, which seriously affects the user's shooting experience. For example, when a user performs rapid continuous shooting, the first 4 photos may be captured normally, but when capturing the fifth photo, because the frame queue is already full (i.e., the image enhancement and composite processing of the first 4 photos has not yet been completed), the shooting function may not continue to operate, causing the user to be unable to complete the expected shooting requirements in time. This situation confuses users and interrupts the photography experience, significantly reducing the user experience.

### SUMMARY

The disclosure provides a photographing time control method for an electronic device including an image sensor, the method comprises the following steps. A photographing interval time is determined according to a predetermined number of continuous shots and an available storage capacity of a frame queue. Whether to accept a user photo request is determined according to the photographing interval time. When accepting the user photo request, multiple image frames captured by the image sensor temporarily stored to the frame queue. A composite image is generated according to the multiple image frames in the frame queue, and the composite image is stored in a format that complies with an image storage format.

The disclosure also provides an electronic device, which comprises an image sensor and a processor. The processor is coupled to the image sensor. The processor is configured to perform the following operations. A photographing interval time is determined according to a predetermined number of continuous shots and an available storage capacity of a frame queue. Whether to accept a user photo request is determined according to the photographing interval time. When accepting the user photo request, multiple image frames captured by the image sensor temporarily stored to the frame queue. A composite image is generated according to the multiple image frames in the frame queue, and the composite image is stored in a format that complies with an image storage format.

Based on the above, in an embodiment of the disclosure, the photographing interval time may be determined according to the predetermined number of continuous shots and the available storage capacity of the frame queue. Subsequently, it may be determined to accept or not accept the user photo request according to the photographing interval time. Accordingly, the poor experience of unexpected long-time photography interruption due to a full frame queue may be avoided, thereby allowing users to obtain a better photography experience.

### BRIEF DESCRIPTION OF THE DRAWINGS

FIG. 1 is a block diagram illustrating an electronic device according to an embodiment of the disclosure.

FIG. 2 is a flowchart illustrating a photographing time control method according to an embodiment of the disclosure.

FIG. 3A is a schematic diagram illustrating not accepting a user photo request according to an embodiment of the disclosure.

FIG. 3B is a schematic diagram illustrating accepting a user photo request according to an embodiment of the disclosure.

FIG. 4 is a flowchart illustrating a photographing time control method according to an embodiment of the disclosure.

FIG. 5 is a flowchart illustrating the determination of photographing interval time according to an embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference symbols are used in the drawings and descriptions to represent the same or similar parts. These embodiments are only a part of the disclosure and do not disclose all possible embodiments of the disclosure. More precisely, these embodiments are merely examples of the devices and methods within the scope of the claims of the disclosure.

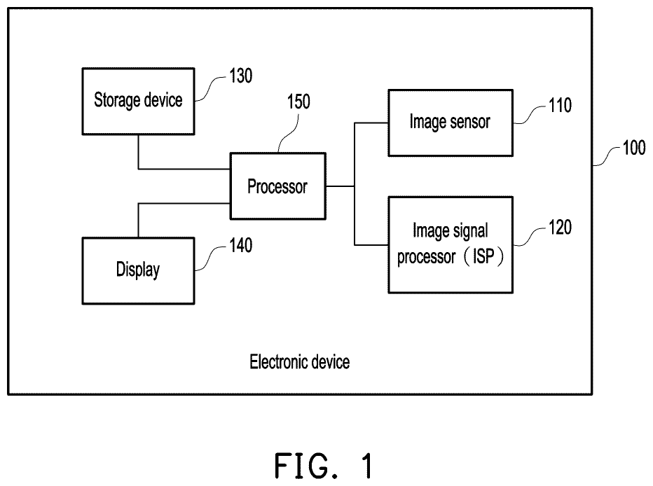

Referring to FIG. 1, the electronic device 100 may comprise an image sensor 110, an image signal processor (ISP) 120, a storage device 130, a display 140, and a processor 150. The electronic device 100 may be, for example, a smartphone, a digital camera, a tablet computer, a game console, an electronic wearable device, or a photographic device, or various electronic devices with image capturing function, and the type of the electronic device 100 is not limited thereto.

In one embodiment, the image sensor 110 is configured to capture images and comprises a lens, an image sensing component, and other components and. The lens is used for light path control and comprises an optical lens. The image sensing component is configured to provide image sensing function. The image sensing component comprises a photosensitive component, such as a Charge Coupled Device (CCD), a Complementary Metal-Oxide Semiconductor (CMOS) component, or other components, which is not limited by the disclosure. The lens may converge imaging light on the image sensing component to achieve the purpose of extracting images.

The image signal processor (ISP) 120 is configured to process image data in real-time. The image signal processor 120 may obtain raw image data from the image sensor 110 and perform front-end image processing on the raw image data. For example, the image signal processor 120 may perform image optimization processes such as contrast enhancement, color correction, sharpening, noise reduction, etc. on the raw image data.

The storage device 130 is configured to store files, images, instructions, program codes, software modules and other data, which may be, for example, any type of fixed or removable random access memory (RAM), read-only memory (ROM), flash memory, hard disk or other similar devices, integrated circuits or combinations thereof.

The display 140 may be a Liquid Crystal Display (LCD), Light Emitting Diode (LED) display, Organic Light Emitting Diode (OLED) display, or various other types of displays, which is not limited by the disclosure. The display 140 may be configured to display the program operation interface of the camera application, shooting preview screen, and shooting result screen, etc.

The processor 150 is coupled to the display 140, the image sensor 110, and the storage device 130. In one embodiment, the processor 150 is a central processing unit (CPU), an application processor (AP), or other programmable general-purpose or special-purpose microprocessor, digital signal processor (DSP), image signal processor (ISP), graphics processing unit (GPU), or other similar devices, integrated circuits, or combinations thereof. In some embodiments, the processor 150 may execute instructions or program codes in the storage device 130 to implement various steps of the photographing time control method in the embodiments of the disclosure.

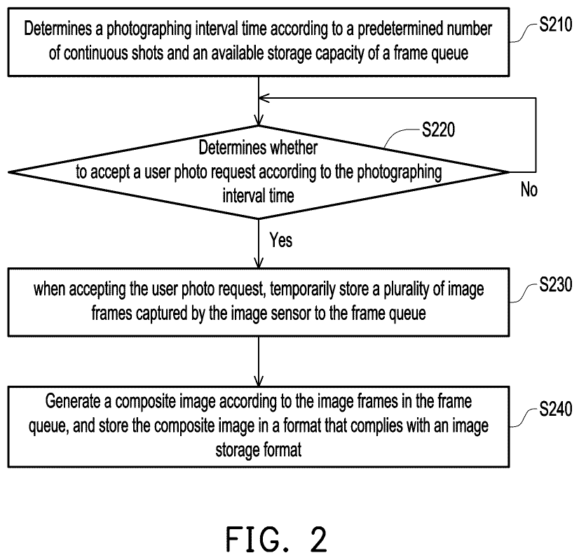

FIG. 2 is a flowchart illustrating a photographing time control method according to an embodiment of the disclosure. Referring to FIG. 2, the method of this embodiment may be executed by the electronic device 100 of FIG. 1. The details of each step in FIG. 2 will be explained below in conjunction with the components shown in FIG. 1.

At step S210, the processor 150 may determine a photographing interval time according to a predetermined number of continuous shots and an available storage capacity of a frame queue. Specifically, the frame queue is configured to buffer image frames captured by the image sensor 110, so that the processor 150 can perform subsequent image post-processing on these image frames. In some embodiments, the frame queue is established by a camera application or an image processing framework. The aforementioned image post-processing may be, for example, HDR composite processing for generating High Dynamic Range Imaging (HDR) images, or image composite processing for generating long exposure images, etc., which is not limited by the disclosure. When performing image post-processing, the processor 150 needs to use multiple image frames to generate a composite image. For example, the processor 150 needs 5 image frames to perform HDR composite processing to generate one HDR image.

It should be noted that the number of image frames that can be temporarily stored in the frame queue is limited, that is, the frame queue has an available storage capacity. For example, the frame queue may store at most multiple image frames for generating N composite images. The available storage capacity of the frame queue may depend on factors such as the computing power and storage capability of the electronic device 100, as well as the complexity of image post-processing. When the frame queue has already stored multiple image frames for generating 2 composite images, the available storage capacity of the frame queue only allows for storing multiple image frames for generating (N−2) more composite images.

In some embodiments, the predetermined number of continuous shots is a preset fixed value. Alternatively, the predetermined number of continuous shots may be a dynamic value determined by the user or the photographing situation. Furthermore, the predetermined number of continuous shots may be manually set by the user. Alternatively, the predetermined number of continuous shots may be decided by the processor 150 according to the photographing situation or the photographing mode selected by the user. The predetermined number of continuous shots is at least greater than 1.

In some embodiments, the processor 150 determines the photographing interval time according to the predetermined number of continuous shots and the available storage capacity of the frame queue, where the photographing interval time may be the time consumed for executing one-time photographing procedure. Specifically, in order to avoid the situation where the frame queue is filled up causing the electronic device 100 to be unable to respond to the user photo request to extract images, the processor 150 may extend the time consumed for each photographing procedure to ensure that the frame queue has enough space to temporarily store new image frames for each photograph. In some embodiments, the processor 150 decides the photographing interval time by comparing the predetermined number of continuous shots with the available storage capacity of the frame queue.

At step S220, the processor 150 may determine whether to accept the user photo request according to the photographing interval time. In some embodiments, the processor 150 may detect whether the shutter key is pressed to detect the user photo request. The shutter key may be a physical button or a virtual button displayed on the touch screen. When the shutter key is pressed, the processor 150 may receive the user photo request. When receiving a user photo request, the processor 150 determines whether the previous photographing procedure triggered by the previous user photo request has ended according to the photographing interval time. When it is determined based on the photographing interval time that the previous photographing procedure has not yet ended, the processor 150 does not accept the user photo request until the previous photographing procedure is completed. When it is determined based on the photographing interval time that the previous photographing procedure has ended, the processor 150 accepts the user photo request.

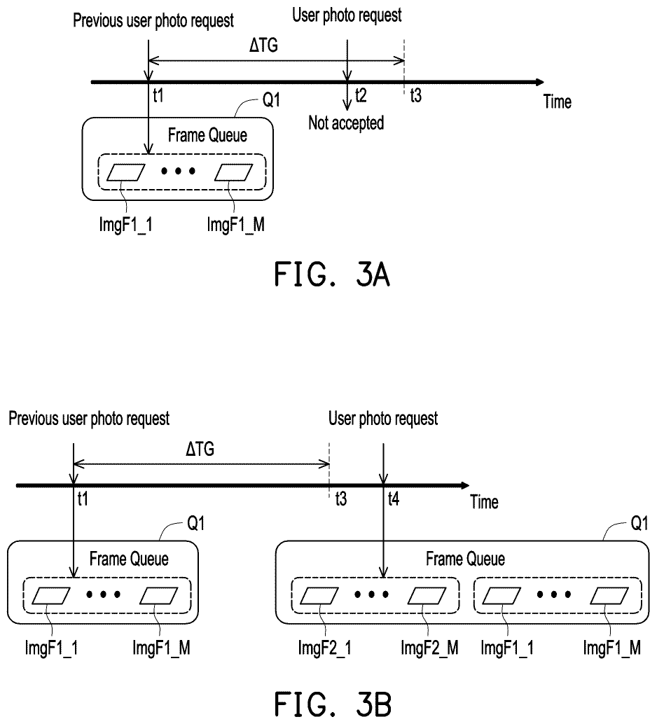

For example, referring to FIG. 3A, the processor 150 may receive a previous user photo request at time point t1, and record M image frames ImgF1_1 to ImgF1_M to the frame queue Q1 according to the previous user photo request. Subsequently, when the processor 150 receives a user photo request at time point t2 before time point t3, the processor 150 does not accept this user photo request. As shown in FIG. 3A, since the user issues the user photo request within the photographing interval time ΔTG between time point t1 and time point t3, the processor 150 does not accept the user photo request at time point t2. The photographing interval time ΔTG may be the procedure execution time of the previous photographing procedure of the previous user photo request.

At step S230, when accepting the user photo request, the processor 150 temporarily stores multiple image frames extracted by the image sensor 110 to the frame queue.

For example, referring to FIG. 3B. The processor 150 may receive a previous user photo request at time point t1, and record M image frames ImgF1_1 to ImgF1_1 to the frame queue Q1 according to the previous user photo request. Subsequently, when the processor 150 receives a user photo request at time point t4 after time point t3, the processor 150 may accept this user photo request because the previous photographing procedure has ended. As shown in FIG. 3B, since the user issues the user photo request after the photographing interval time ΔTG required by the previous photographing procedure, the processor 150 accepts the user photo request at time point t4. Afterwards, the processor 150 may record M image frames ImgF2_1 to ImgF2_M to the frame queue Q1 according to the user photo request at time point t4.

At step S240, the processor 150 may generate a composite image according to multiple image frames in the frame queue, and store the composite image that matches the image storage format. The processor 150 may read multiple image frames from the frame queue to generate one composite image. Then, the processor 150 may perform image post-processing on the multiple image frames to compose a composite image, and compress it into an image storage format for saving. For example, the above image storage format may be JPEG format, but is not limited to this. When the processor 150 completes the generation and storage of a composite image, the frame queue may release the multiple image frames associated with that composite image. By releasing image frames that are no longer needed, the frame queue can maintain within a reasonable capacity range.

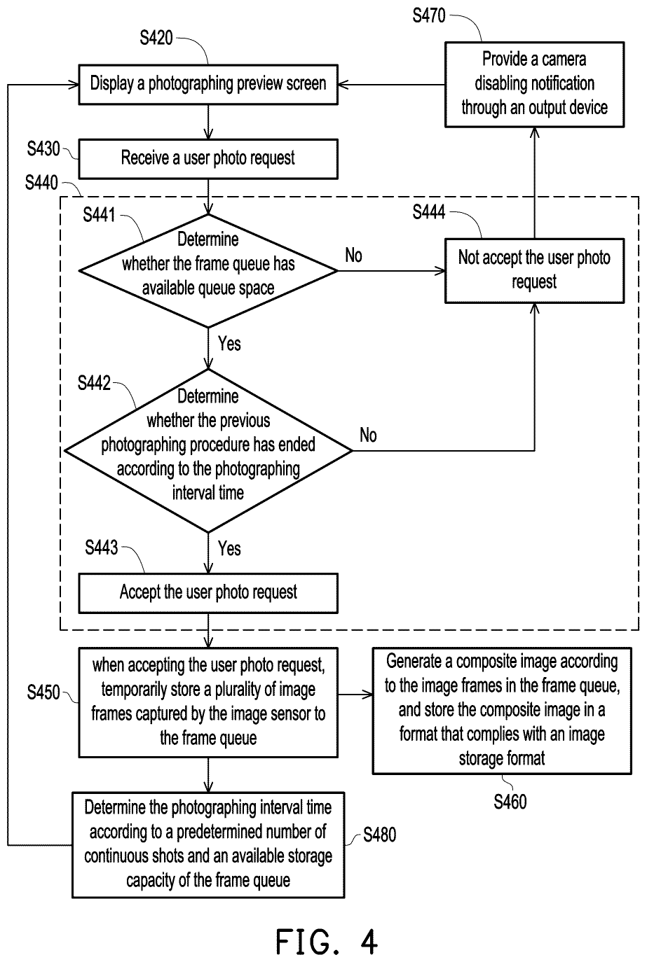

FIG. 4 is a flowchart illustrating a photographing time control method according to an embodiment of the disclosure. Referring to FIG. 4, the method of this embodiment may be executed by the electronic device 100 of FIG. 1, and the details of each step in FIG. 4 will be explained in conjunction with the components shown in FIG. 1.

At step S420, the processor 150 may display a photographing preview screen through the display 140. At step S430, the processor 150 may receive a user photo request. Furthermore, the processor 150 may control the display 140 to show the photographing preview screen based on continuous multiple images from the image sensor 110, making it convenient for the user to frame and decide the content to photograph. When the user presses the shutter key, the processor 150 may receive the user photo request. The shutter key may be a physical button or a virtual button displayed on the touch screen.

At step S440, the processor 150 may determine whether to accept the user photo request according to the photographing interval time. In this embodiment, step S440 may be implemented as steps S441 to S444.

At step S441, the processor 150, in response to receiving the user photo request, may determine whether the frame queue has available queue space. When the determination at step S441 is negative, it represents that the frame queue is full and cannot store any more image data. Therefore, when the determination at step S441 is negative, the process proceeds to step S444. At step S444, when the frame queue does not have available queue space, the processor 150 does not accept the user photo request.

At step S442, when the frame queue has available queue space, the processor 150 determines whether the previous photographing procedure has ended according to the photographing interval time.

When the determination at step S442 is negative, it represents that the previous photographing procedure has not ended, and the process proceeds to step S444. In some embodiments, when a timer's result from timing the previous user photo request to the current user photo request is less than the photographing interval time, the processor 150 may determine that the previous photographing procedure has not ended. At step S444, when the previous photographing procedure has not ended, the processor 150 does not accept the user photo request. When the determination at step S442 is positive, it represents that the time interval between two consecutive user photo requests is long enough, and the process proceeds to step S443. When a timer's result from timing the previous user photo request to the current user photo request is greater than the photographing interval time, the processor 150 may determine that the previous photographing procedure has ended. At step S443, when the previous photographing procedure has ended, the processor 150 determines to accept the user photo request.

At step S450, when accepting the user photo request, the processor 150 temporarily stores multiple image frames captured by the image sensor 110 to the frame queue. Specifically, when the frame queue has available queue space and the timer has timed to the photographing interval time, the Frame Capture Thread begins to work, and the processor 150 controls the image sensor 110 to capture multiple image frames through the Frame Capture Thread.

At step S460, the processor 150 may generate a composite image according to multiple image frames in the frame queue, and stores the composite image that matches the image storage format. When the processor 150 completes the generation and storage of a composite image, the frame queue may release the multiple image frames associated with that composite image. Specifically, after a set of images is captured and recorded in the frame queue, the image enhancement post-processing thread extracts this set of images from the frame queue for image enhancement processing or image composition processing.

Afterwards, at step S480, the processor 150 determines a photographing interval time according to a predetermined number of continuous shots and an available storage capacity of a frame queue.

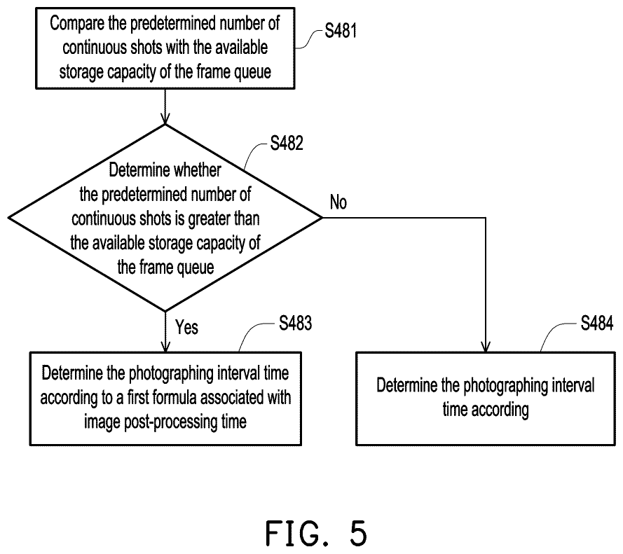

Referring to FIG. 5, which illustrates a flowchart of determining the photographing interval time according to an embodiment of the disclosure. In some embodiments, step S480 may be implemented as steps S481 to S484.

At step S481, the processor 150 may compare the predetermined number of continuous shots with the available storage capacity of the frame queue. At step S482, the processor 150 may determine whether the predetermined number of continuous shots is greater than the available storage capacity of the frame queue.

It should be explained that the frame queue may temporarily store multiple image frames configured to generate at most Q composite images. In the embodiment, the available storage capacity of the frame queue is defined as the maximum number of composite images that the frame queue can support to generate.

When the determination at step S482 is yes, proceed to step S483. At step S483, when the predetermined number of continuous shots is greater than the available storage capacity of the frame queue, the processor 150 determines the photographing interval time according to a first formula associated with image post-processing time. When the determination at step S482 is no, proceed to step S484. At step S484, when the predetermined number of continuous shots is less than or equal to the available storage capacity of the frame queue, the processor 150 determines the photographing interval time according to a second formula not associated with image post-processing time. That is, according to whether the predetermined number of continuous shots is greater than the available storage capacity of the frame queue, the processor 150 may use different formulas to decide the photographing interval time. In some embodiments, the image post-processing time is the time required for the processor 150 to perform image post-processing on multiple image frames to generate one composite image.

In some embodiments, the first formula is calculated based on an image post-processing time, while the second formula is not calculated based on the image post-processing time. That is, when the predetermined number of continuous shots is greater than the available storage capacity of the frame queue, the processor 150 needs to consider the image post-processing time, therefore the processor 150 may decide the photographing interval time according to the image post-processing time. When the predetermined number of continuous shots is less than or equal to the available storage capacity of the frame queue, the processor 150 may decide the photographing interval time without considering the image post-processing time.

In some embodiments, when the predetermined number of continuous shots is greater than the available storage capacity of the frame queue, the processor 150 may decide the photographing interval time according to the predetermined number of continuous shots, the available storage capacity of the frame queue, the image extraction time and the image post-processing time. The first formula may be represented as formula (1) below.

$$T = \frac{F \times Q + P \times ( N - Q )}{N - 1} , N > Q \qquad formula ( 1 )$$

Where, T represents the photographing interval time; N represents the predetermined number of continuous shots; Q represents the available storage capacity of the frame queue; F represents an image extraction time; P represents the image post-processing time. It should be explained that the image extraction time may be the single image exposure time multiplied by the number of frames of multiple image frames configured to generate a single composite image.

For example, assuming that the exposure time of a single image is 33 ms and that 10 image frames are used to generate one composite image, the image capture time would be 330 ms (i.e., 33×10=330). In this case, when the predetermined number of continuous shots is 6 images, the available storage capacity of the image frame queue is 4 images, and the post-processing time is 2500 ms, then the shooting interval time T would be calculated as: T=(330×4+2500×(6−4))/(6−1)=1264 ms.

In some embodiments, when the predetermined number of continuous shots is less than or equal to the available storage capacity of the frame queue, the processor 150 may decide the photographing interval time according to the predetermined number of continuous shots and the image extraction time. The second formula may be represented as formula (2) below.

$$T = \frac{F \times N}{N - 1} , N \leq Q \qquad formula ( 2 )$$

Where, T represents the photographing interval time; N represents the predetermined number of continuous shots; F represents an image extraction time.

For example, assuming that the exposure time of a single image is 33 ms and that 10 image frames are used to generate one composite image, the image capture time would be 330 ms (i.e., 33×10=330). In this case, when the predetermined number of continuous shots is 3 images, the available storage capacity of the image frame queue is 4 images, and the post-processing time is 2500 ms, then the shooting interval time T would be calculated as: T=(330×3)/(3−1)=495 ms.

At step S470, when the user photo request is not accepted, the processor 150 provides a camera disabling notification through an output device. The output device may be, for example, a display 140, a light device, or a speaker, etc. The camera disabling notification may be a visual notification or a voice notification. In some embodiments, the processor 150 may display a camera disabling notification prompting the user to wait on the operation interface of the camera application through the display 140, where the camera disabling notification may be text, an icon, or a combination thereof.

In summary, in the disclosure, the photographing interval time may be decided according to the predetermined number of continuous shots and the available storage capacity of the frame queue. When the predetermined number of continuous shots is greater than the available storage capacity of the frame queue, the photographing interval time may be decided according to the image post-processing time. Subsequently, it may be determined whether to accept the user photo request according to the photographing interval time. Based on this, it may avoid the poor experience of unexpected long photography interruptions due to a full frame queue, thereby allowing users to obtain a better photography experience. In shooting scenarios with a high number of continuous shots, the photography results generated through image post-processing can be steadily produced at a consistent speed, thus avoiding the predicament of having to wait for a longer time to take photos.

Although this disclosure has been described with the embodiments of the invention as above, it is not intended to limit the disclosure. Any person skilled in the art with ordinary knowledge, without departing from the spirit and scope of this disclosure, may make some modifications and refinements. Therefore, the scope of protection of this disclosure shall be defined by the appended claims.

What is claimed is:

1. A photographing time control method, adapted to an electronic device comprising an image sensor, the method comprising:
determining a photographing interval time according to a predetermined number of continuous shots and an available storage capacity of a frame queue;
determining whether to accept a user photo request according to the photographing interval time;
temporarily storing a plurality of image frames captured by the image sensor to the frame queue when accepting the user photo request; and
generating a composite image according to the plurality of image frames in the frame queue, and storing the composite image in a format that complies with an image storage format.

2. The photographing time control method as claimed in claim 1, wherein the step of determining the photographing interval time according to the predetermined number of continuous shots and the available storage capacity of the frame queue comprises:
comparing the predetermined number of continuous shots with the available storage capacity of the frame queue;
determining the photographing interval time according to a first computation formula when the predetermined number of continuous shots is greater than the available storage capacity of the frame queue; and
determining the photographing interval time according to a second computation formula when the predetermined number of continuous shots is less than or equal to the available storage capacity of the frame queue.

3. The photographing time control method as claimed in claim 2, wherein the first computation formula is calculated based on an image post-processing time, and the second computation formula is not calculated based on the image post-processing time.

4. The photographing time control method as claimed in claim 2, wherein the step of determining the photographing interval time according to the first computation formula when the predetermined number of continuous shots is greater than the available storage capacity of the frame queue comprises:
determining the photographing interval time according to the predetermined number of continuous shots, the available storage capacity of the frame queue, an image capture time and the image post-processing time.

5. The photographing time control method as claimed in claim 2, wherein the first computation formula is represented as follows:
$$T = \frac{F \times Q + P \times ( N - Q )}{N - 1} ,$$
wherein T represents the photographing interval time; N represents the predetermined number of continuous shots; Q represents the available storage capacity of the frame queue; F represents an image capture time; and P represents the image post-processing time.

6. The photographing time control method as claimed in claim 2, wherein the step of determining the photographing interval time according to the second computation formula when the predetermined number of continuous shots is less than or equal to the available storage capacity of the frame queue comprises:
determining the photographing interval time according to the predetermined number of continuous shots and an image capture time.

7. The photographing time control method as claimed in claim 1, wherein the step of determining whether to accept the user photo request according to the photographing interval time comprises:
in response to receiving the user photo request, determining whether a previous photographing procedure has ended according to the photographing interval time;
determining to accept the user photo request when determining that the previous photographing procedure has ended according to the photographing interval time; and
determining not to accept the user photo request when determining that the previous photographing procedure has not ended according to the photographing interval time.

8. The photographing time control method as claimed in claim 7, wherein a timer is triggered to start timing when a previous user photo request is allowed.

9. The photographing time control method as claimed in claim 7, wherein the step of determining whether the previous photographing procedure has ended according to the photographing interval time in response to receiving the user photo request comprises:
in response to receiving the user photo request, determining whether the frame queue has available queue space;
determining whether the previous photographing procedure has ended according to the photographing interval time when the frame queue has available queue space; and
determining not to accept the user photo request when the frame queue does not have the available queue space.

10. The photographing time control method as claimed in claim 1, further comprising:
providing a camera disable notification through an output device when not accepting the user photo request.

11. An electronic device, comprising:
an image sensor; and
a processor, coupled to the image sensor, and configured to:
determine a photographing interval time according to a predetermined number of continuous shots and an available storage capacity of a frame queue;
determine whether to accept a user photo request according to the photographing interval time;
temporarily store a plurality of image frames captured by the image sensor to the frame queue when accepting the user photo request; and
generate a composite image according to the plurality of image frames in the frame queue, and store the composite image in a format that complies with an image storage format.
